(19) United States
(12) Patent Application Publication
(10) Pub. No.: US 2014/0027315 A1
(43) Pub. Date: Jan. 30, 2014

(54) DUAL CONTAINMENT PRESSURE VESSEL FOR STORAGE AND TRANSPORT OF URANIUM HEXAFLUORIDE

(71) Applicant: COLUMBIANA HI TECH LLC, Greensboro, NC (US)

(72) Inventor: Thomas F. DOUGHERTY, Chagrin Falls, OH (US)

(73) Assignee: COLUMBIANA HI TECH LLC, Greensboro, NC (US)

(21) Appl. No.: 13/951,149

(22) Filed: Jul. 25, 2013

Related U.S. Application Data
(60) Provisional application No. 61/675,749, filed on Jul. 25, 2012.

(51) Int. Cl. F17C 1/00

(52) U.S. Cl. CPC F17C 1/00
USPC 206/6

(57) ABSTRACT

A cylinder for storage and transport of uranium hexafluoride includes a generally tubular main body with a distally arranged end member defining an interior region. An interior tubular member is received in the interior region. A tube end member is attached to an end of the tubular member opposite the end member. First and second chime ends are on respective ends of the main body. First and second chime end members are disposed in the first and second chime ends respectively. The end member, the interior tubular member and the tube end member form a first containment structure. The tubular main body, the first and second chime ends and the first and second chine end members form a second containment structure.

### CROSS-REFERENCE TO RELATED APPLICATIONS

This application claims priority to U.S. Provisional Patent Application No. 61/675,749, filed on Jul. 25, 2012, the disclosures of which are incorporated herein by reference.

### BACKGROUND

Uranium Hexafluoride (UF₆ or “Hex”) is a compound used in the uranium enrichment process. It is used in the nuclear industry to produce nuclear fuel. UF₆ is, however, considered to be hazardous and toxic and is very reactive and corrosive. As such, certain measures are taken to ensure containment of UF₆ during storage, and especially during transport. Typically, UF₆ is stored and transported in cylinders, for example ANSI N14.1 30B, 30C or 30D cylinders. Generally, regulations require that these cylinders be placed in protective shipping packages (PSPs), e.g. overpacks, during transportation to protect the cylinders during potential accident conditions. Hypothetical accident conditions include situations where the PSP could be dropped or impacted, subjected to a fire event, immersed in water, or otherwise damaged.

Typically, natural or unenriched UF₆ contains the isotope U₂₃₅ in a weight percent of about 7/10 of one percent. Enriched UF₆ has U₂₃₅ in a weight percentage greater than 7/10 of one percent. The isotope U₂₃₅ emits neutrons and, in the enriched state, which gives enriched UF₆ its radioactive characteristics. The industry standard for the commercial use of enriched UF₆ includes weight percentages extending up to and above five percent. In the enriched state, UF₆ can become critical given certain circumstances, for which the chance of becoming critical increases with the amount and/or concentration of U₂₃₅ present. Moderators can slow the movement of emitted neutrons thereby increasing the possibility of a collision, which can trigger a critical event. Persons skilled in the art refer to the K_{eff} factor, where a K_{eff} greater than 1.0 relates to a condition where the number of neutrons are increasing leading toward a critical event. Conversely for a K_{eff} less than 1.0, neutrons are being absorbed. Water is one such moderator of UF₆. Accordingly, it is important to ensure that UF₆ does not become exposed to water or water based substances. If the storage container valves and plugs become damaged and/or deteriorate, the possibility of contact with water significantly increases, as does the possibility of a critical event.

One factor contributing to a critical event pertains to the amount of U₂₃₅ present within a cylinder. Generally, the amount of any substance that can be stored in a given container is limited by the container's construction, e.g. the dimensions of the cylinder walls. For precautionary reasons, it is common that regulations limit the weight quantity of U₂₃₅ that can be stored in a container to five (5) weight percent of the total volume of material stored in a cylinder. However, in recent years the industry has been desirous of shipping and storing enriched UF₆ containing U₂₃₅ in weight percentages in excess of five (5) percent.

Further, Reprocessed uranium includes a high number of nuclides, including, but not limited to, U₂₃₈, and U₂₃₅ and U₂₃₆, and even U₂₃₄, U₂₃₃, and U₂₃₂. As such, natural uranium (unenriched or enriched) and reprocessed uranium are not stored or transported in the same types of systems.

Due to the above, it is generally desired that any container for the storage of shipment of reprocessed uranium be leak-tight, as understood in the industry. There is also a desire for redundant containment in such containers.

### BRIEF SUMMARY

This pertains to cylinders for storage and transport of Uranium Hexafluoride.

A cylinder for storage and transport of uranium hexafluoride includes a generally tubular main body with a distally arranged end member defining an interior region. An interior tubular member is received in the interior region. A tube end member is attached to an end of the tubular member opposite the end member. First and second chime ends are on respective ends of the main body. First and second chime end members are disposed in the first and second chime ends respectively. The end member, the interior tubular member and the tube end member form a first containment structure. The tubular main body, the first and second chime ends and the first and second chine end members form a second containment structure.

Advantages of the embodiments described below will become apparent to those skilled in the art

### BRIEF DESCRIPTION OF THE DRAWINGS

FIG. 1 is a partial cutaway side view of 1 cylinder for storage and transport of Uranium Hexafluoride.

FIG. 2 is a partial cutaway side view of the first containment structure of the cylinder of FIG. 1.

FIG. 3 is an enlarged view of a portion of the first containment structure of FIG. 2.

FIG. 4 is an enlarged view of the main valve and the main valve cap of the first containment structure of FIG. 2.

FIG. 5 is an enlarged view of the end plug and the end test port of the first containment structure of FIG. 2.

FIG. 6 is a partial cutaway side view of the second containment structure of the cylinder of FIG. 1.

FIG. 7 is an enlarged view of a girth seam weld of the second containment structure of FIG. 6.

FIG. 8 is an exemplary view of a skirt seam weld of the second containment structure of FIG. 6.

FIG. 9 is an enlarged view of a first portion of the second containment structure of FIG. 6.

FIG. 10 is an enlarged view of a second portion of the second containment structure of FIG. 6.

### DETAILED DESCRIPTION

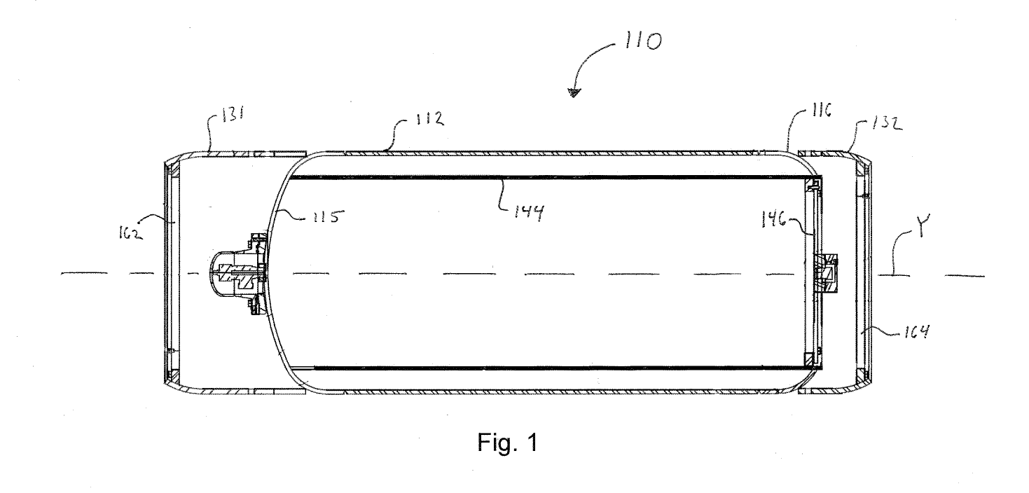

Referring to the drawings, there is shown in FIG. 1 a cylinder 110 for storage and transport of uranium hexafluoride. The cylinder 110 may be placed in an overpack (not shown) and then in a cradle (not shown) for storage or transport.

The cylinder 110 is constructed to contain hazardous and/or radioactive materials, one example of which includes Uranium Hexafluoride (also termed UF₆). It must be appreciated that regulations may exist which provide certain design or usage constraints for a vessel of this type.

The cylinder 110 may be of standard size, such as for 30B, 30C or 30D containers as regulated by governmental agencies.

The cylinder 110 is a generally cylindrical container, which may be made of metal, such as steel and in particular stainless steel, and includes a generally tubular main body 112 along with a distally arranged end member 115 and a distally arranged end ring 116.

In one example, the main body 112 may be constructed from sheet steel roll-formed into the straight cylindrical configuration. In one embodiment, the sheet steel may have a minimum thickness of 13/32 inch and have a length of substantially 81 ½ inches long. When roll-formed, the I.D., i.e. inner diameter, may be 29 ¼ inches. Additionally, the type of steel utilized in constructing the main body 112 aside from a stainless steel, such as ASTM SA Type 304 stainless steel, the steel may be ASME SA-516 Grade 70 carbon steel. However, other grades of steel may be used that conform to the proper regulatory restrictions including but not limited to Title 49 of the Code of Federal Regulations. As best shown in FIG. 8, once the main body 112 has been formed into a cylinder, a seam 113 may be fused together by welding to join the sides of the main body 112. In one embodiment, the seam 113 may be fusion welded. However, any method of constructing the main body 112 may be chosen as is appropriate for use there on

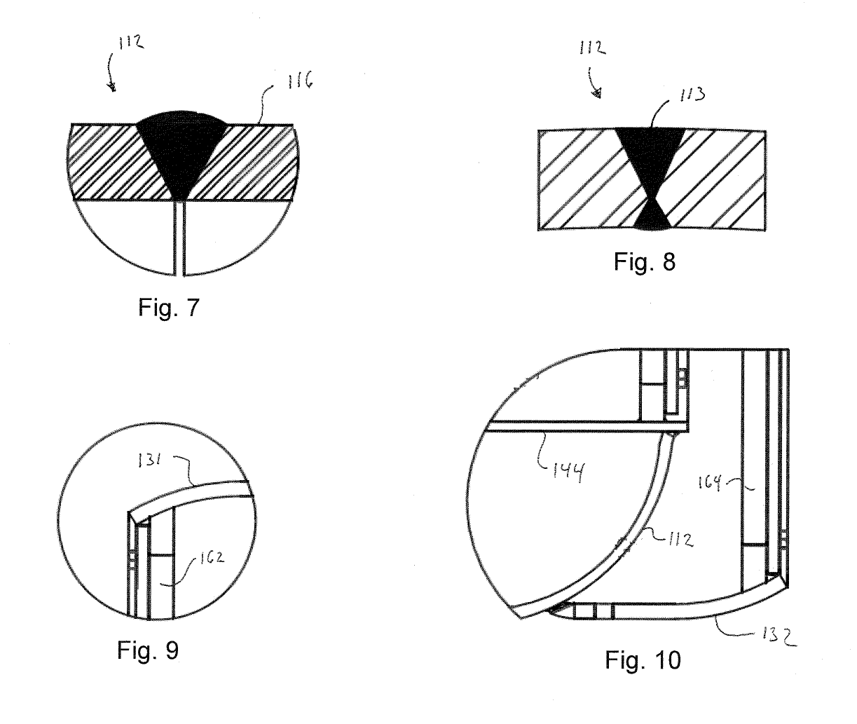

The end member 115 and the end ring 116 may be formed integrally with the remainder of the main body 112 or may be formed separately and attached in any suitable manner, such as welding, see FIG. 7.

The end member 115 and the end ring 116 may be constructed from the same type of material as that of the main body 112, for example SA-516 Grade 70 carbon steel. Further, the thickness of the end member 115 and the ring member 116 may be thicker than the main body 112 as so desired. In one embodiment, the thickness is approximately 0.7 inch. A minimum thickness may be 11/16 inch. However, any thickness above the minimum thickness may be chosen with sound judgment as is appropriate for use with the embodiments of the subject invention. The end member 115 may be fashioned in the shape of a disk or plate having an outer diameter corresponding to the inner diameter of the main body 112. The end member 115 may be curved at their respective center portions thereby defining a domed shape with a corresponding radius that extends to a circumferential edge. In one embodiment, the corresponding radius is uniform from a center point to the circumferential edge. The end ring 116 may be fashioned in the shape of a ring having an outer diameter corresponding to the inner diameter of the main body 112.

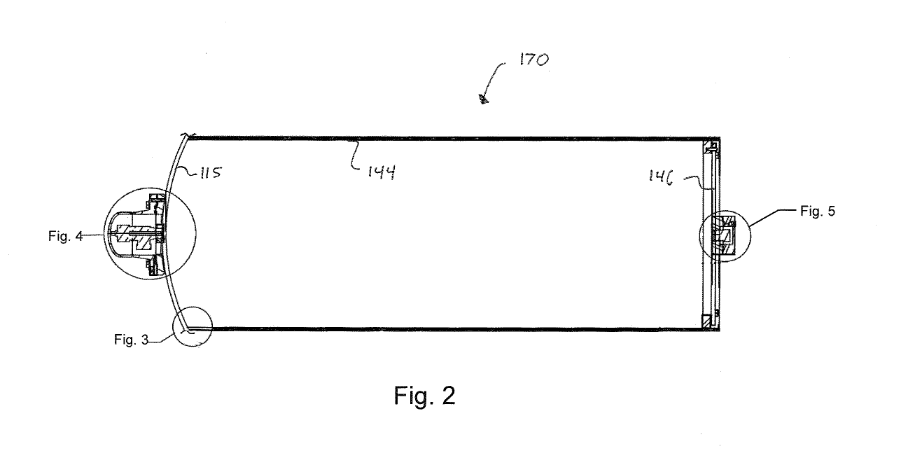

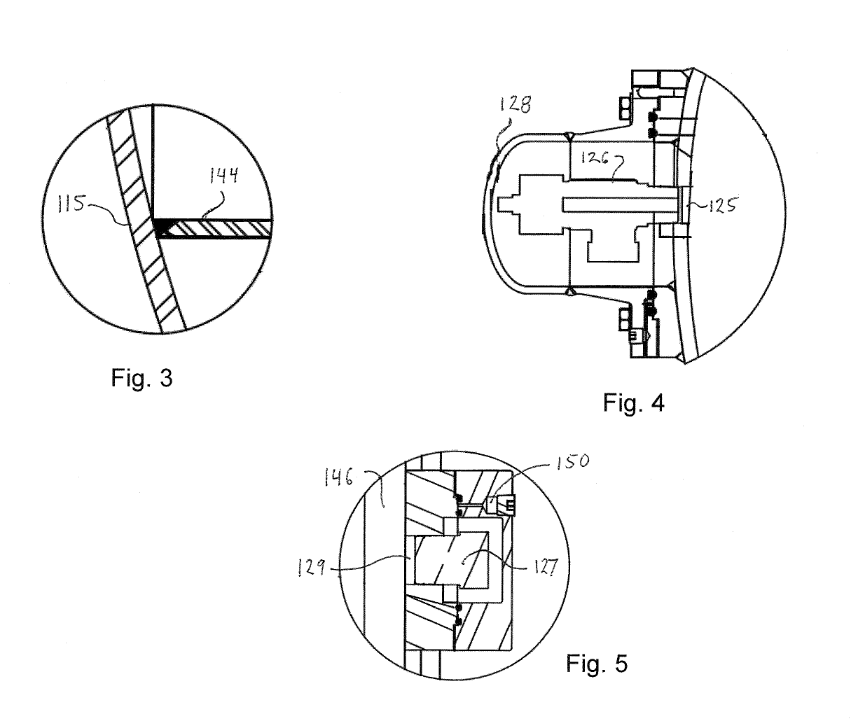

The main body 112 with the end member 115 define an interior region for receiving an interior tubular member 144. The tubular member 144 may be a continuous member such a that of steel pipe. The member 144 is inserted into the main body 112 and attached, for example by welding, to the end member 115, as best shown in FIG. 3. A tube end member 146 is attached to the end of the tubular member 144 opposite the end member 115 thereby forming a first containment structure 170, see FIG. 2, defining a generally longitudinal compartment for the storage of material in the cylinder 110. However, it must be understood that the interior tubular member 144 may be of any suitable shape such as by construction incorporating steel sheets welded together in a generally polygonal fashion. It is further noted that the type of material used to construct the interior tubular member 144 is not limited to steel. Rather steel alloys or other metal alloys may be selected as is appropriate.

The main body 112 of the cylinder 110 is generally symmetrically fashioned around a central, longitudinal axis Y, and has a generally circular cross section, which is particularly suited for storing pressurized Uranium Hexafluoride, although neither are required.

As best shown in FIG. 4, for the addition or subtraction of contained substance, e.g. for filling and emptying the first containment structure 170, a main port 125 to allow flow access is included that allows for the ingress and/or egress of Uranium Hexafluoride, along with any suitable desired flow control mechanism, such as a valve 126. In the illustrative example the main port 125 is formed into the end member 115 along the longitudinal axis Y, although such is not required. An optional valve cap or cover 128 and assembly for sealing the valve cover 128 are incorporated into the first containment structure 170.

Additionally, as best shown in FIG. 5, a second port 129 is formed in the tube end member 146 for transferring Uranium Hexafluoride into and out of the cylinder 110 as desired. A plug 127 is provided in the second port 129

It is well known in the art that substances like Uranium Hexafluoride react violently with water or water based substances. Accordingly, the main port 125, along with the valve 126 and the second port 129 and the plug 127, may be specifically constructed and installed to withstand damage during use and/or deterioration from exposure to ambient conditions that would allow substances of this nature to intermix, as an additional measure of safety.

The cylinder 110 may further include chime ends 131 and 132 on respective ends of the main body 112. Each of the chime ends 131 and 132 may extend from the main body 12 and/or the end members 115 or end ring 116 respectively. The chime ends 131 and 132 may function to protect the ends of the first containment structure 170. In this manner, should the cylinder 10 impact the ground or other structure, force from the impact may be translated to the chime ends 131 and 132 protecting the first containment structure 170. It is expressly noted that the length of the first and second chime ends 131 and 132 need not necessarily be equal. That is to say that the first chime end 131 may be substantially longer than the second chime end 132, or vice-versa. Any difference in length may be selected that appropriately protects the various components, e.g. valves, plugs and the like, installed into cylinder 110. In an exemplary manner, the first chime end 131 or the second chime end 132 may have a length of substantially 9 inches. In another example the first chime end 131 or the second chime end 132 may have a length of substantially 12 inches. It is noted that the lengths of the chime ends 131 and 132 may vary widely. However, regulatory constraints may be in place that restrict the overall length of the container. Accordingly, any proportional length of the chime ends 131 and 132 may be chosen that falls within the required guidelines governing the use and construction of the cylinder 110.

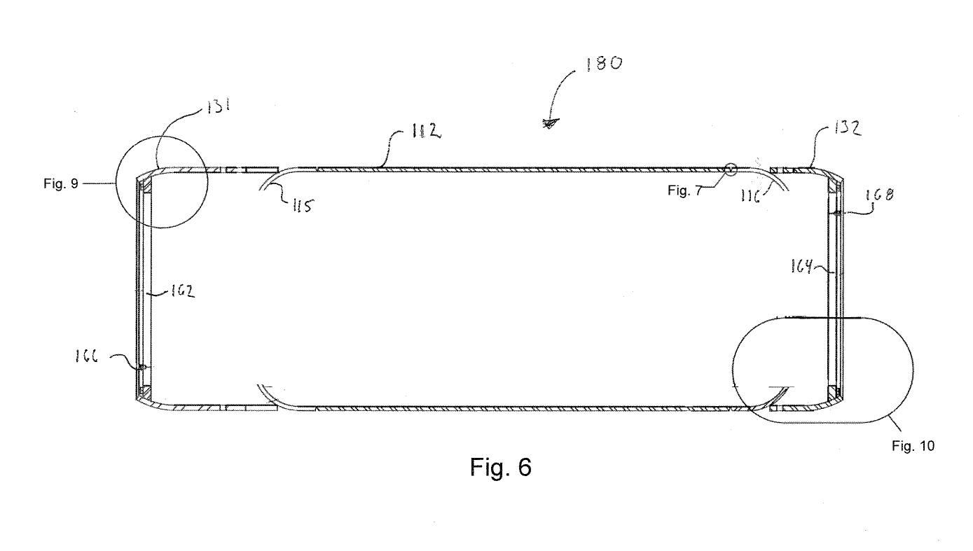

First and second chime end members 162 and 164 are disposed in the first and second chime ends 131 and 132 respectively, thereby forming a second containment structure 180, see FIG. 6, defining a generally longitudinal compartment for the housing of the first containment structure 170. The first and second chime end members 162 and 164 each optionally include a respective test port 166 and 168.

While description has been made herein with reference to certain embodiments, it must be understood that modifications and alterations will occur to others upon a reading and understanding of this description. It is intended to include all such modifications and alterations insofar as they come within the scope of the appended claims or the equivalence thereof.

What is claimed is:

1. A cylinder for storage and transport of uranium hexafluoride comprising:
a generally tubular main body with a distally arranged end member defining an interior region;
an interior tubular member received in the interior region;
a tube end member attached to an end of the tubular member opposite the end member;
first and second chime ends on respective ends of the main body; and
first and second chime end members disposed in the first and second chime ends respectively;
wherein the end member, the interior tubular member and the tube end member form a first containment structure; and
wherein the tubular main body, the first and second chime ends and the first and second chine end members form a second containment structure.
